(19) United States
(12) Patent Application Publication
(10) Pub. No.: US 2023/0327338 A1
(43) Pub. Date: Oct. 12, 2023

(54) ANTENNA MODULE AND COMMUNICATION DEVICE EQUIPPED WITH THE SAME

(71) Applicant: Murata Manufacturing Co., Ltd., Nagaokakyo (JP)

(72) Inventor: Natsumi MINAMITANI, Nagaokakyo (JP)

(73) Assignee: Murata Manufacturing Co., Ltd., Nagaokakyo (JP)

(21) Appl. No.: 18/335,181

(22) Filed: Jun. 15, 2023

Related U.S. Application Data
(63) Continuation of application No. PCT/JP2021/042069, filed on Nov. 16, 2021.

(30) Foreign Application Priority Data
Dec. 16, 2020 (JP) 2020-208336

(51) Int. Cl. H01Q 9/04; H01Q 9/06; H01Q 1/48; H01Q 21/24

(52) U.S. Cl. CPC H01Q 9/0407; H01Q 9/065; H01Q 1/48; H01Q 21/24

(57) ABSTRACT

An antenna module includes a dielectric substrate, radiating elements disposed in or on the dielectric substrate, and a dielectric layer. The radiating element is disposed next to the radiating element in a plan view seen from the direction normal to the dielectric substrate. The dielectric layer is disposed to cover the radiating element. The radiating element is a linear antenna. The dielectric constant of the dielectric layer is higher than the dielectric constant of the dielectric substrate. The thickness of the dielectric layer is smaller than the thickness of the dielectric substrate.

### CROSS-REFERENCE TO RELATED APPLICATIONS

This application is a continuation of, and claims the benefit of priority to international patent application no. PCT/JP2021/042069, filed Nov. 16, 2021, and which claims priority to Japanese patent application no. 2020-208336, filed Dec. 16, 2020. The entire contents of all prior applications are incorporated herein by reference.

### TECHNICAL FIELD

The present disclosure relates to antenna modules and communication devices equipped with the antenna modules, and more specifically relates to a technique for expanding the area of radiation of a radio wave in an antenna module.

### BACKGROUND ART

Japanese Patent No. 6384550 (Patent Document 1) describes a wireless communication module in which an end-fire antenna (dipole antenna) and a plate-like patch antenna are arranged on the same substrate. With the foregoing configuration, the dipole antenna and the patch antenna can be operated as an array antenna by setting the polarization direction of a radio wave emitted from the dipole antenna and the polarization direction of a radio wave emitted from the patch antenna in the same direction. Accordingly, the directivity can vary continuously from the end-fire direction (direction parallel to a surface of the substrate) to the boresight direction (direction vertical to the substrate).

### CITATION LIST

### Patent Document

Patent Document 1: Japanese Patent No. 6384550

### SUMMARY

### Technical Problem

In the wireless communication module described in Japanese patent No. 6384550 (Patent Document 1), a reflector pattern is disposed in between the dipole antenna and the patch antenna, and the dipole antenna thus emits a radio wave approximately in the opposite direction to the patch antenna. However, in general, the beam direction of a radio wave emitted from the dipole antenna spreads out widely. Thus, with the configuration disclosed in Japanese patent No. 6384550 (Patent Document 1), part of the radio wave emitted from the dipole antenna is emitted across a wide area ranging from the end-fire direction to the boresight direction. Accordingly, the area of radiation caused by the dipole antenna partially overlaps the area of radiation caused by the patch antenna. In the dipole antenna, because of this radiation of a radio wave to the overlapping area, power being used for radiation in the end-fire direction may be limited. Therefore, there is room for improvement regarding efficiency of a radio wave being emitted from the dipole antenna in the end-fire direction.

The present disclosure, among other inventive aspects, resolves the foregoing issues by, for example, improving the efficiency of a radio wave being emitted in the end-fire direction in an antenna module in which a plurality of radiating elements including a linear antenna are disposed.

### Solution to Problem

An antenna module according to the present disclosure includes a dielectric substrate, a first radiating element and a second radiating element disposed in or on the dielectric substrate, and a first dielectric layer. The second radiating element is disposed next to the first radiating element in a plan view seen from a direction normal to the dielectric substrate. The first dielectric layer is disposed to cover the second radiating element. The second radiating element is a linear antenna. A dielectric constant of the first dielectric layer is higher than a dielectric constant of the dielectric substrate. A thickness of the first dielectric layer is smaller than a thickness of the dielectric substrate.

### Exemplary Advantageous Effects

According to the antenna module of the present disclosure, the second radiating element which is a linear antenna is covered by the dielectric layer that has a thickness smaller than a thickness of the dielectric substrate and is made of a material whose dielectric constant is higher than a dielectric constant of the dielectric substrate. According to the foregoing configuration, the second radiating element is more likely to emit a radio wave in the end-fire direction than in the boresight direction. Therefore, it becomes possible to improve the efficiency of a radio wave being emitted in the end-fire direction.

### BRIEF DESCRIPTION OF DRAWINGS

FIG. 1 is a block diagram of a communication device in which an antenna module according to exemplary Embodiment 1 is employed.

FIG. 2 illustrates a plan view and a side transparent view of the antenna module according to exemplary Embodiment 1.

FIG. 3 is a side transparent view of an antenna module according to Modification 1.

FIG. 4 is a side transparent view of an antenna module according to Modification 2.

FIG. 5 is a side transparent view of an antenna module according to Modification 3.

FIG. 6 is a side transparent view of an antenna module according to Modification 4.

FIG. 7 is a side transparent view of an antenna module according to Modification 5.

FIG. 8 is a side transparent view of an antenna module according to Modification 6.

FIG. 9 is a plan view of an antenna module according to Embodiment 2.

FIG. 10 is a plan view of an antenna module according to Modification 7.

FIG. 11 is a plan view of an antenna module according to Modification 8.

### DETAILED DESCRIPTION

Hereinafter, exemplary embodiments of the present disclosure will be described in detail with reference to the drawings. Note that the same reference characters are assigned to the same or corresponding parts in the drawings, and the descriptions thereof will not be repeated.

### Embodiment 1

(Basic Configuration of Communication Device)

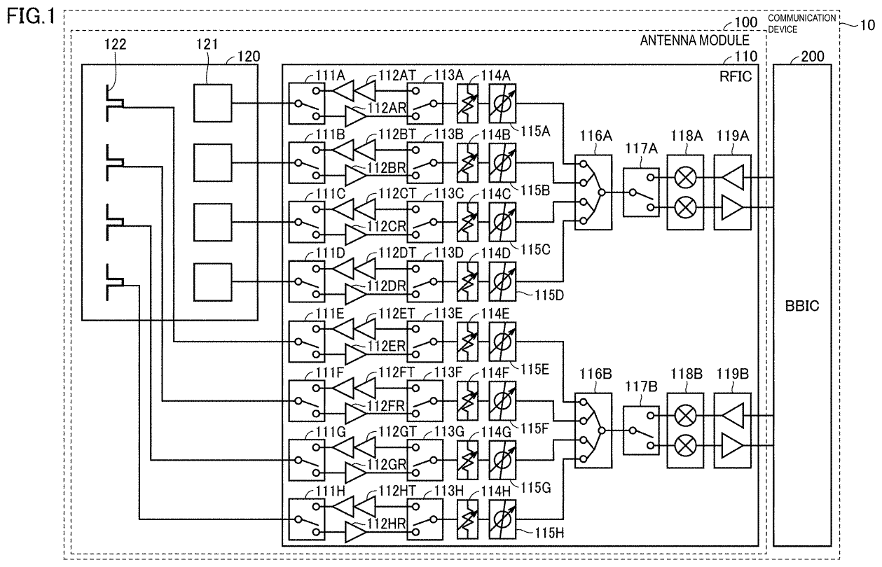

FIG. 1 is a block diagram of an example of a communication device 10 in which an antenna module 100 according to exemplary Embodiment 1 is employed. The communication device 10 is, for example, a mobile terminal such as a mobile phone, a smartphone, a tablet, or the like, a personal computer having communication capability, or the like.

Referring to FIG. 1, the communication device 10 includes the antenna module 100 and a base band integrated circuit (BBIC) 200. The BBIC 200 makes up a baseband signal processing circuit. The antenna module 100 includes a radio frequency integrated circuit (RFIC) 110 that is an example of a feed circuit and an antenna device 120. The communication device 10 up-converts a signal, which is transferred from the BBIC 200 to the antenna module 100, into a radio frequency signal and emits this radio frequency signal from the antenna device 120, and further down-converts a radio frequency signal received by the antenna device 120 and performs processing on the down-converted signal in the BBIC 200.

In the antenna device 120 of FIG. 1, at least one radiating element 121 (first radiating element) and at least one radiating element 122 (second radiating element) are disposed. In the example of FIG. 1, the case where radio waves of the same frequency band (for example, a 28 GHz band) are emitted from the radiating element 121 and the radiating element 122 is described. Alternatively, the example may be a case where radio waves of different frequency bands (for example, a 28 GHz band and a 39 GHz band) are emitted from the radiating element 121 and the radiating element 122.

In the antenna module 100 of exemplary Embodiment 1, the radiating element 121 is a planar antenna such as a patch antenna or a slot antenna. On the other hand, the radiating element 122 is a linear antenna such as a monopole antenna, a dipole antenna, an inverted-F antenna, or a bowtie antenna. In the example of FIG. 1, the radiating element 121 is a patch antenna having approximately a square flat plate shape, and the radiating element 122 is a dipole antenna. Note that the radiating element 121 may alternatively be a linear antenna.

For ease of description, FIG. 1 illustrates an example of the configuration in which the radiating element 121 and the radiating element 122 which make up the antenna device 120 each includes four elements disposed as a one-dimensional array. However, the number of each of the radiating element 121 and the radiating element 122 may be one or two or more other than four. Further, the number of the radiating elements 121 and the number of the radiating elements 122 are not necessarily the same.

The RFIC 110 includes switches 111A to 111H, 113A to 113H, 117A, and 117B, power amplifiers 112AT to 112HT, low-noise amplifiers 112AR to 112HR, attenuators 114A to 114H, phase shifters 115A to 115H, signal combiner/splitters 116A and 116B, mixers 118A and 118B, and amplifier circuits 119A and 119B. Of these constituent elements, the configuration including the switches 111A to 111D, 113A to 113D, and 117A, the power amplifiers 112AT to 112DT, the low-noise amplifiers 112AR to 112DR, the attenuators 114A to 114D, the phase shifters 115A to 115D, the signal combiner/splitter 116A, the mixer 118A, and the amplifier circuit 119A is circuitry for the radiating element 121. Further, the configuration including the switches 111E to 111H, 113E to 113H, and 117B, the power amplifiers 112ET to 112HT, the low-noise amplifiers 112ER to 112HR, the attenuators 114E to 114H, the phase shifters 115E to 115H, the signal combiner/splitter 116B, the mixer 118B, and the amplifier circuit 119B is circuitry for the radiating element 122.

In a case that a radio frequency signal is to be transmitted, the switches 111A to 111H and 113A to 113H are switched to the sides of the power amplifiers 112AT to 112HT, and the switches 117A and 117B are connected to transmitting side amplifiers of the amplifier circuits 119A and 119B. In a case that a radio frequency signal is to be received, the switches 111A to 111H and 113A to 113H are switched to the sides of the low-noise amplifiers 112AR to 112HR, and the switches 117A and 117B are connected to receiving side amplifiers of the amplifier circuits 119A and 119B.

Signals transferred from the BBIC 200 are amplified in the amplifier circuits 119A and 119B and up-converted in the mixers 118A and 118B. Transmitting signals that are up-converted radio frequency signals are each split into four signals in the signal combiner/splitters 116A and 116B, and these split signals are fed to different radiating elements 121 and 122 after traveling through corresponding signal paths. The directivity of the antenna device 120 can be adjusted by individually adjusting the degree of phase shift in the phase shifters 115A to 115H that are disposed in the respective signal paths.

Received signals that are radio frequency signals received by the respective radiating elements 121 and 122 are transferred to the RFIC 110 and combined in the signal combiner/splitters 116A and 116B after traveling through the four different signal paths. Combined received signals are down-converted in the mixers 118A and 118B, amplified in the amplifier circuits 119A and 119B, and transferred to the BBIC 200.

The RFIC 110 is formed as, for example, a one-chip integrated circuit component including the circuit configuration described above. Alternatively, devices (switches, power amplifiers, low-noise amplifiers, attenuators, and phase shifters) in the RFIC 110 corresponding to each radiating element may be formed as a one-chip integrated circuit component for each radiating element.

(Configuration of Antenna Module)

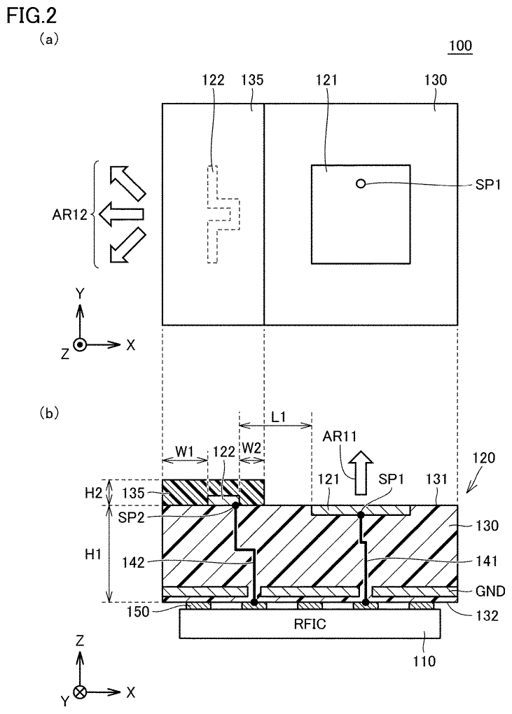

Next, referring to FIG. 2, the configuration of the antenna module 100 according to exemplary Embodiment 1 is described in detail. The upper section of FIG. 2 (FIG. 2(a)) is a plan view of the antenna module 100. Further, the lower section of FIG. 2 (FIG. 2(b)) is a side transparent view of this antenna module 100. In the following description, for ease of description, an example is described using an antenna module in which one radiating element 121 and one radiating element 122 are formed. Note that as illustrated in FIG. 2, a thickness direction of the antenna module 100 is defined as the Z-axis direction, and a plane vertical to the Z-axis direction is defined by the X-axis and the Y-axis. Further, in each drawing, the positive direction of the Z-axis may be referred to as top surface side, and the negative direction of the Z-axis may be referred to as bottom surface side.

Referring to FIG. 2, the antenna module 100 includes, in addition to the RFIC 110 and the radiating elements 121 and 122, a dielectric substrate 130, a ground electrode GND, feed lines 141 and 142, and a dielectric layer 135. Note that in the plan view of FIG. 2(a), the RFIC 110 and the ground electrode GND are omitted.

The dielectric substrate 130 is, for example, a low temperature co-fired ceramics (LTCC) multilayer substrate, a multilayer resin substrate in which resin layers, each of which is made of a resin such as epoxy, polyimide, or the like, are laminated, a multilayer resin substrate in which resin layers, each of which is made of a liquid crystal polymer (LCP) having a lower dielectric constant, are laminated, a multilayer resin substrate in which resin layers, each of which is made of a fluorine-based resin, are laminated, or a ceramics multilayer substrate other than LTCC. Note that the dielectric substrate 130 does not necessarily have a multilayer structure and may alternatively be a single layer substrate.

In plan view seen from the direction normal to the dielectric substrate 130 (Z-axis direction), the dielectric substrate 130 has a substantially rectangular shape. On a top surface 131 (surface in the positive direction of the Z-axis) side of the dielectric substrate 130, the radiating element 121 is disposed. The radiating element 121 may be configured to be exposed to the surface of the dielectric substrate 130 or may be disposed in an internal layer of the dielectric substrate 130. Further, the ground electrode GND is disposed on a bottom surface 132 (surface in the negative direction of the Z-axis) of the dielectric substrate 130 or in an internal layer on the bottom surface 132 side as illustrated in FIG. 2. That is to say, in FIG. 2, the ground electrode GND is disposed in between the radiating element 121 and the bottom surface 132. Note that the “top surface 131” and the “bottom surface 132” correspond to “first surface” and “second surface” of the present disclosure, respectively.

The radiating element 122 is disposed next to the radiating element 121 on the top surface 131 of the dielectric substrate 130. In the example of FIG. 2, the radiating element 122 is disposed at a location that is separated from the radiating element 121 toward the negative direction side of the X-axis in such a way that a radiating portion extends in the Y-axis direction. A separation distance L1 between the radiating element 121 and the radiating element 122 is set to L1>λ/2, where λ is the wavelength of a radio wave emitted from each radiating element. The foregoing arrangement with the separation distance L1 enables interference between a radio wave emitted from the radiating element 121 and a radio wave emitted from the radiating element 122 to be suppressed. Note that in the case where the radiating elements 121 and 122 emit radio waves of different wavelengths (λ1, λ2: λ1>λ2), the separation distance L1 is set to be longer than ½ of λ1 (L1>λ1/2), λ1 being the longer one of the two wavelengths.

The RFIC 110 is mounted on the bottom surface 132 of the dielectric substrate 130 with solder bumps 150 interposed therebetween. Note that the RFIC 110 may be connected to the dielectric substrate 130 using, instead of the solder connection, a multipole connector.

A radio frequency signal is transferred to the radiating element 121 from the RFIC 110 via a feed line 141. The feed line 141 passes through the ground electrode GND from the RFIC 110 and is connected to a feed point SP1 from the bottom surface side of the radiating element 121. That is to say, the feed line 141 transfers a radio frequency signal to the feed point SP1 of the radiating element 121. The feed point SP1 is provided at a location that is shifted from the center of the radiating element 121 in the positive direction of the Y-axis. By supplying a radio frequency signal to the feed point SP1, a radio wave whose polarization direction is the Y-axis direction is emitted from the radiating element 121.

A radio frequency signal is transferred to the radiating element 122 from the RFIC 110 via a feed line 142. The feed line 142 passes through the ground electrode GND from the RFIC 110 and is connected to a feed point SP2 of the radiating element 122. By supplying a radio frequency signal to the feed point SP2, a radio wave whose polarization direction is the Y-axis direction is emitted from the radiating element 122.

The dielectric layer 135 is disposed on the top surface 131 of the dielectric substrate 130 and covers the radiating element 122. The dielectric layer 135 is made of, for example, glass or ceramic and is made of a material that has a higher dielectric constant than a dielectric constant of the dielectric substrate 130. For example, the dielectric constant of the dielectric layer 135 is 6 to 30, and the dielectric constant of the dielectric substrate 130 is 3 to 4. Further, a thickness (dimension in the Z-axis direction) H2 of the dielectric layer 135 is smaller than a thickness H1 of the dielectric substrate 130 (H1>H2).

With a flat plate shape patch antenna such as the radiating element 121, basically, a radio wave is emitted in the direction (arrow AR11 in FIG. 2) normal to the radiating element 121 and directions (namely, boresight direction) within the range of about ±45 degrees from the direction normal to the radiating element 121, and a radio wave is less likely to be emitted in directions along the surface of the dielectric substrate 130 (namely, end-fire direction; arrow AR12 in FIG. 2). On the other hand, with a dipole antenna such as the radiating element 122, a radio wave is emitted in all directions including the end-fire direction. Therefore, by emitting radio waves using the radiating element 121 which is a patch antenna and the radiating element 122 which is a dipole antenna, the area of radiation ranging from the boresight direction to the end-fire direction can be ensured.

However, with a linear antenna such as a dipole antenna, a radio wave spreads across a wide range in a case that the radio wave is emitted, and thus the intensity of the radio wave emitted in each direction becomes weaker relative to the power being supplied. Further, as in the case with the antenna module 100 according to Embodiment 1, in a case that the radiating element 121 which is a patch antenna is used together with the radiating element 122, the radiating element 122 also emits a radio wave in a direction that overlaps the direction of a radio wave being emitted from the radiating element 121. Accordingly, in the configuration in which a patch antenna that mostly emits a radio wave in the boresight direction and a dipole antenna that emits in all directions are simply disposed side by side, there is room for improvement regarding the efficiency of the radio wave in the end-fire direction.

In the antenna module 100 of Embodiment 1, the radiating element 122 is covered by the dielectric layer 135 that has a smaller thickness and a higher dielectric constant than the dielectric substrate 130. With the foregoing configuration, the dielectric layer 135 functions as a waveguide, and of a radio wave being emitted from the radiating element 122, the mode of a radio wave being emitted in the boresight direction is suppressed. As a result, the intensity of a radio wave being emitted in the end-fire direction increases. In other words, a beam of the radio wave being emitted from the radiating element 122 can be concentrated in the end-fire direction. Therefore, it becomes possible to improve the efficiency of the radio wave being emitted in the end-fire direction.

Further, the inventor has found that a radio wave is likely to be emitted in a direction opposite to the radiating element 121 (that is, the negative direction of the X-axis) by making a distance W1 (first distance) from the radiating element 122 to the edge of the dielectric substrate 130 in a direction (first direction) from the center of the radiating element 121 to the center of the radiating element 122 longer than a distance W2 (second distance) from the radiating element 122 to the edge of the dielectric layer 135 in a direction (second direction) from the center of the radiating element 122 to the center of the radiating element 121. By setting the spatial relationship between the radiating element 122 and the dielectric layer 135 as described above, a beam of a radio wave emitted from the radiating element 122 can be concentrated in an outward direction from the antenna module 100, and thus it becomes possible to further improve the efficiency of the radio wave being emitted in the end-fire direction. Note that the center of the radiating element 122 which is a dipole antenna refers to the location at the center in an extending direction of an electrode. In other words, in FIG. 2, the center of the radiating element 122 which is a dipole antenna corresponds to the location of the center of the radiating element 122 in the Y-axis direction.

Note that although it is not illustrated in the drawings, the beam from the radiating element 122 may be concentrated in the outward direction from the antenna module 100 by providing a reflector for the radiating element 122 in between the radiating element 121 and the radiating element 122.

As described above, the antenna module 100 of Embodiment 1 has the configuration in which the radiating element 121 which is a patch antenna and the radiating element 122 which is a dipole antenna are disposed next to each other on the dielectric substrate 130 and the radiating element 122 is covered by the dielectric layer 135 that is made of a material having a smaller thickness and a higher dielectric constant than the dielectric substrate 130. With the foregoing configuration, the radiating element 122 is more likely to emit a radio wave in the end-fire direction than in the boresight direction. Therefore, in the antenna module 100 of exemplary Embodiment 1, it becomes possible to improve the efficiency of a radio wave being emitted in the end-fire direction.

### Modification 1

Regarding the antenna module 100 of exemplary Embodiment 1, the configuration is described in which the ground electrode GND is disposed over substantially the whole area of the dielectric substrate 130 in plan view of the dielectric substrate 130 seen from the direction normal to the dielectric substrate 130.

However, if the ground electrode GND is disposed on the bottom surface side of the radiating element 122 which is a dipole antenna, the radiating element 122 couples with the ground electrode GND, and part of a current flows from the radiating element 122 to the ground electrode GND side. In some cases, this narrows the frequency band width of a radio wave being emitted from the radiating element 122.

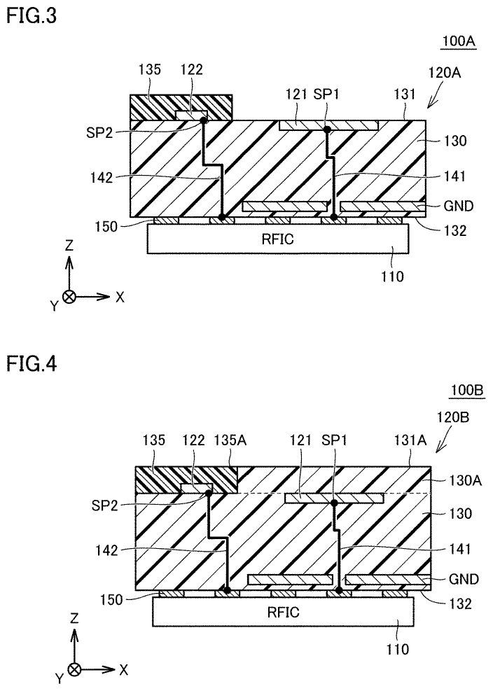

In an antenna device 120A included in an antenna module 100A of Modification 1 illustrated in FIG. 3, the ground electrode GND formed in the dielectric substrate 130 is disposed on the bottom surface side of the radiating element 121 but not disposed on the bottom surface side of the radiating element 122. In other words, the ground electrode GND is disposed in an area that does not overlap the radiating element 122 in plan view of the dielectric substrate 130 seen from the direction normal to the dielectric substrate 130. Accordingly, compared with the antenna module 100 of Embodiment 1, the coupling between the radiating element 122 and the ground electrode GND is suppressed. Accordingly, in the antenna module 100A of Modification 1, it becomes possible to further improve the efficiency of a radio wave being emitted from the radiating element 122 in the end-fire direction.

### Modification 2

In the antenna modules of exemplary Embodiment 1 and Modification 1, the dielectric layer 135 is disposed on the top surface 131 of the dielectric substrate 130, and there is a level difference between the portion having the dielectric layer 135 and the portion not having the dielectric layer 135. In a process of mounting an antenna module on a mounting substrate or the like, the antenna module may be picked up by suction using a nozzle. In this case, as described above, if there is a level difference on a surface of a component, air may leak from a level difference part, and it may be difficult to properly pick up the antenna module.

In an antenna device 120B included in an antenna module 100B of Modification 2 illustrated in FIG. 4, a dielectric layer 130A whose material has a lower dielectric constant than the dielectric layer 135 is formed at the level difference part between the dielectric layer 135 and the dielectric substrate 130. In other words, the dielectric layer 130A is disposed in the area where the dielectric layer 135 is not present in plan view seen from the direction normal to the dielectric substrate 130. Furthermore, the location of a top surface 135A of the dielectric layer 135 and the location of a top surface 131A of the dielectric layer 130A are at substantially the same level. Note that the dielectric layer 130A may be made of a different material from the dielectric substrate 130 or may be made of the same material as the dielectric substrate 130.

As described above, by planarizing the surface of the antenna module by reducing the level difference, it becomes possible to improve reliability of antenna module handling in a fabrication process of the antenna module.

### Modifications 3 to 6

In exemplary Embodiment 1 and Modifications 1 and 2 described above, the configuration is described in which the dipole antenna (radiating element 122) is disposed on the top surface 131 of the dielectric substrate 130 and the dielectric layer 135 is disposed to cover the radiating element 122. However, the radiating element 122 is not necessarily disposed on the top surface 131 of the dielectric substrate 130.

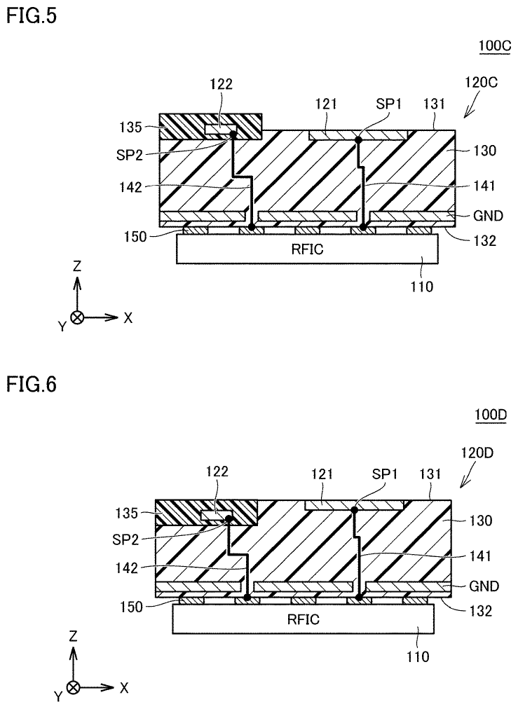

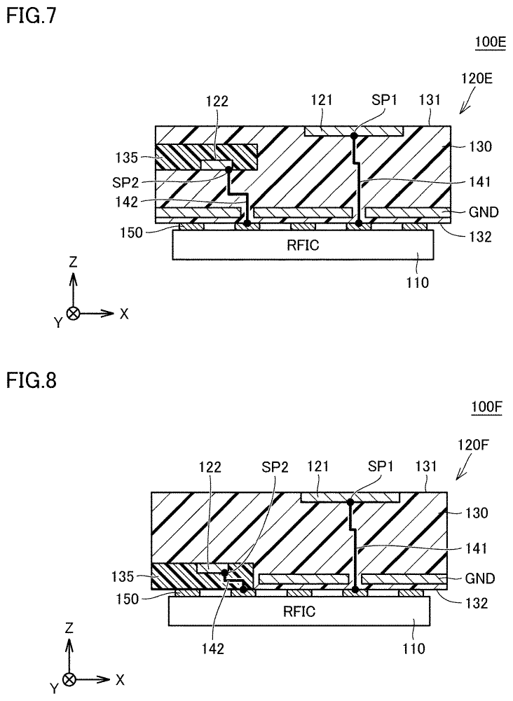

For example, as in the cases of antenna modules 100C to 100F according to Modification 3 to Modification 6 illustrated in FIG. 5 to FIG. 8, respectively, the configuration may be such that at least part of the dielectric layer 135 is embedded in an internal layer of the dielectric substrates 130. In these cases, as in the cases of antenna devices 120C and 120D of FIG. 5 and FIG. 6, the whole of the radiating element 122 may be covered by the dielectric layer 135, or as in the cases of antenna devices 120E and 120F of FIG. 7 and FIG. 8, the radiating element 122 may be disposed to be in contact with the top surface or the bottom surface of the dielectric layer 135.

Each of the antenna modules of the Modifications 3 to 6 also has the configuration in which the radiating element 122 is covered by the dielectric layer 135 that is made of a material having a smaller thickness and a higher dielectric constant than the dielectric substrate 130. Because of this, it becomes possible to improve the efficiency of a radio wave being emitted in the end-fire direction.

### Embodiment 2

In exemplary Embodiment 1 and Modifications thereof, the configuration is described using the example in which one radiating element 121 and one radiating element 122 of the antenna module are disposed. In exemplary Embodiment 2, a case of an array antenna in which a plurality of radiating elements 121 and a plurality of radiating elements 122 are disposed is described.

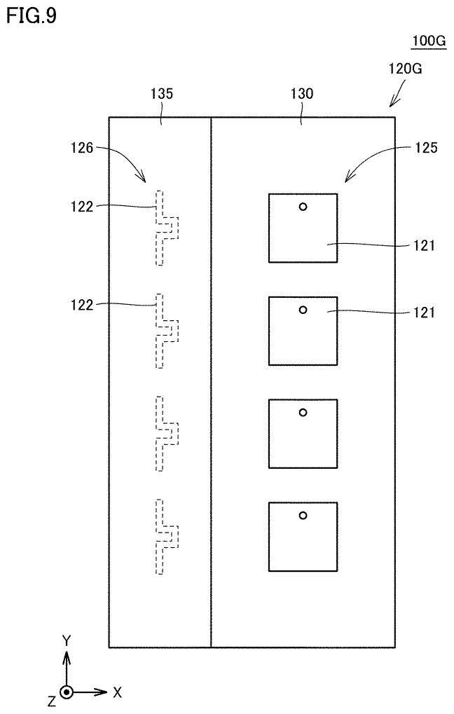

FIG. 9 is a plan view of an antenna module 100G according to exemplary Embodiment 2. An antenna device 120G included in the antenna module 100G has the configuration in which four sets of the radiating elements 121 and 122 described referring to FIG. 2 are disposed. More specifically, the antenna device 120G includes an antenna group 125 (first antenna group) in which four radiating elements 121 are disposed in a line in the Y-axis direction and an antenna group 126 (second antenna group) in which four radiating elements 122 are disposed in a line in the Y-axis direction to be separated from the four radiating elements 121. Furthermore, the dielectric layer 135 having a higher dielectric constant is disposed to cover the antenna group 126. Note that regarding the antenna groups 125 and 126, the spatial relationship between the radiating element 121 and the corresponding radiating element 122 and the arrangement of the dielectric layer 135 are similar to those of exemplary Embodiment 1, and the description thereof is not repeated.

Because of the arrangement of the dielectric layer 135 having a higher dielectric constant, also in an array antenna such as the antenna module 100G, the radiating elements 122 of the antenna group 126 are more likely to emit radio waves in the end-fire direction than in the boresight direction. Therefore, it becomes possible to improve the efficiency of a radio wave being emitted in the end-fire direction.

### Modification 7

In Modification 7, an array antenna whose configuration enables radio wave radiation in two different directions using linear antennas is described.

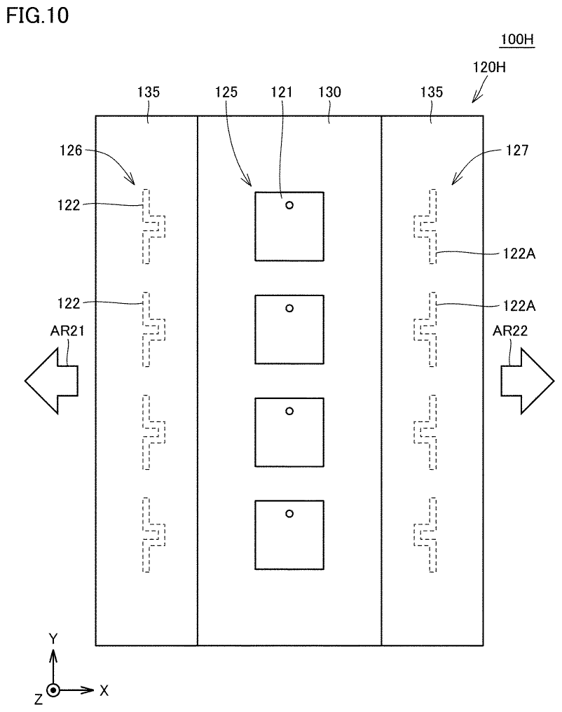

FIG. 10 is a plan view of an antenna module 100H according to Modification 7. An antenna device 120H included in the antenna module 100H has the configuration in which an antenna group 127 is further disposed on the X-axis positive direction side of the radiating elements 121 in addition to the configuration of the antenna device 120G of Embodiment 2, and the antenna group 127 includes four radiating elements 122A disposed in a line in the Y-axis direction.

The radiating elements 122A of the antenna group 127 are disposed to face the opposite direction of the radiating elements 122 of the antenna group 126. Accordingly, the radiating elements 122A of the antenna group 127 emit radio waves in the direction opposite to the radiating elements 122. Specifically, the radiating elements 122 emit a radio wave in the negative direction of the X-axis (arrow AR21 in FIG. 10), and the radiating elements 122A emit a radio wave in the positive direction of the X-axis (arrow AR22 in FIG. 10).

Furthermore, the radiating elements 122A are also covered by the dielectric layer 135 that has a smaller thickness and a higher dielectric constant than the dielectric substrate 130.

As described above, also in the array antenna including the two antenna groups 126 and 127 that emit radio waves in two end-fire directions that are different from each other, the radio waves are more likely to be emitted in the end-fire directions than in the boresight direction by covering these antenna groups 126 and 127 with the dielectric layer 135 having a higher dielectric constant. Therefore, it becomes possible to improve the efficiency of a radio wave being emitted in the end-fire directions.

Note that the example of FIG. 10 is described using the case where the antenna groups 126 and 127 emit radio waves in mutually opposite directions of the X-axis. However, the antenna group 126 may be disposed to emit radio waves in the Y-axis direction, and the antenna group 127 may be disposed to emit radio waves in the X-axis direction.

### Modification 8

In Modification 8, an array antenna whose configuration enables radio wave radiation in four different directions using linear antennas is described.

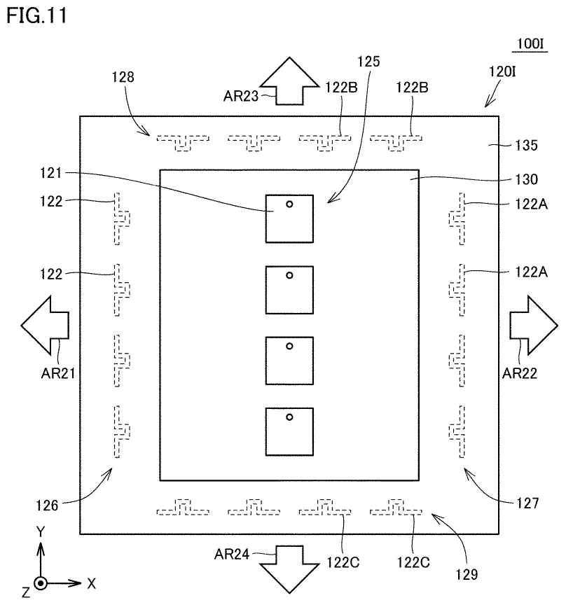

FIG. 11 is a plan view of an antenna module 100I according to Modification 8. An antenna device 120I included in the antenna module 100I has the configuration in which an antenna group 128 (third antenna group) and an antenna group 129 (fourth antenna group) are further disposed in addition to the configuration of the antenna device 120H of Modification 7. More specifically, the antenna group 128 includes four radiating elements 122B that are disposed in a line in the X-axis direction and disposed on the Y-axis positive direction side of the radiating elements 121. Further, the antenna group 129 includes four radiating elements 122C that are disposed in a line in the X-axis direction and disposed on the Y-axis negative direction side of the radiating elements 121.

In the radiating element 122B included in the antenna group 128, a linear electrode extends in the X-axis direction. Further, also in the radiating element 122C included in the antenna group 129, a linear electrode extends in the X-axis direction. Furthermore, the dielectric layer 135 is disposed to cover the antenna groups 128 and 129. The dielectric layer 135 and all the radiating elements included in the antenna groups 128 and 129 are disposed to have a spatial relationship similar to the spatial relationship illustrated in FIG. 2. Because of this, the antenna group 128 emits a radio wave in the positive direction of the Y-axis (arrow AR23 in FIG. 11), and the antenna group 129 emits a radio wave in the negative direction of the Y-axis (arrow AR24 in FIG. 11).

Furthermore, as described above, because these antenna groups 128 and 129 are covered by the dielectric layer 135 having a higher dielectric constant and a smaller thickness than the dielectric substrate 130, radio waves being emitted from the antenna groups 128 and 129 are more likely to be emitted in the end-fire direction than in the boresight direction. Therefore, by using a configuration such as the antenna module 100I, it becomes possible to efficiently emit a radio wave in the end-fire directions in the Y-axis direction in addition to the end-fire directions in the X-axis direction.

Note that Modification 8 is described using the configuration in which the antenna groups 126 to 129 emit radio waves in four different end-fire directions. Alternatively, the configuration may include any three of the antenna groups 126 to 129 for emitting radio waves in three different end-fire directions.

Further, characteristic features described in Modification 1 and Modification 2 may be employed in Embodiment 2 and Modifications 7 and 8. Further, in the configurations of Modifications 7 and 8, the number of the radiating elements included in each antenna group may be one.

It is to be understood that the exemplary embodiments disclosed herein are exemplary in all aspects and are not restrictive. It is intended that the scope of the present disclosure is defined by the claims, not by the description of the exemplary embodiments, and includes all variations which come within the meaning and range of equivalency of the claims.

### REFERENCE SIGNS LIST

10 Communication device, 100, 100A to 1001 Antenna module, 110 RFIC, 111A to 111H, 113A to 113H, 117A, 117B Switch, 112AR to 112HR Low-noise amplifier, 112AT to 112HT Power amplifier, 114A to 114H Attenuator, 115A to 115H Phase shifter, 116A, 116B Signal combiner/splitter, 118A, 118B Mixer, 119A, 119B Amplifier circuit, 120, 120A to 1201 Antenna device, 121, 122, 122A to 122C Radiating element, 125 to 129 Antenna group, 130 Dielectric substrate, 130A, 135 Dielectric layer, 131, 131A, 135A Top surface, 132 Bottom surface, 141, 142 Feed line, 150 Solder bump, 200 BBIC, GND Ground electrode, SP1, SP2 Feed point

1. An antenna module comprising:
a dielectric substrate;
a first radiating element disposed in or on the dielectric substrate;
a second radiating element disposed next to the first radiating element in a plan view seen from a direction normal to the dielectric substrate; and
a first dielectric layer disposed to cover the second radiating element, wherein
the second radiating element is a linear antenna,
a dielectric constant of the first dielectric layer is higher than a dielectric constant of the dielectric substrate, and
a thickness of the first dielectric layer is smaller than a thickness of the dielectric substrate.

2. The antenna module according to claim 1, wherein
the first radiating element is a planar antenna.

3. The antenna module according to claim 1, further comprising:
a ground electrode, wherein
the first radiating element is a patch antenna,
the second radiating element is a dipole antenna,
the dielectric substrate has a first surface that faces a second surface, and
the ground electrode is disposed on the second surface of the dielectric substrate or in between the first radiating element and the second surface in the dielectric substrate.

4. The antenna module according to claim 3, wherein
in the plan view, the ground electrode is disposed in an area that does not overlap the second radiating element.

5. The antenna module according to claim 1, wherein
the first radiating element and the second radiating element are configured to emit radio waves of a same wavelength, and
a distance between the first radiating element and the second radiating element is longer than ½ of the wavelength.

6. The antenna module according to claim 1, wherein
the first radiating element and the second radiating element are configured to emit a radio wave of a first wavelength and a radio wave of a second wavelength, respectively, and
a distance between the first radiating element and the second radiating element is longer than ½ of a longer one of the first wavelength and the second wavelength.

7. The antenna module according to claim 1, wherein
a first direction is a direction from the first radiating element to the second radiating element,
a second direction is a direction from the second radiating element to the first radiating element, and a first distance from the second radiating element to an edge of the first dielectric layer in the first direction is longer than a second distance from the second radiating element to an edge of the first dielectric layer in the second direction.

8. An antenna module comprising:
a dielectric substrate;
a first antenna group disposed in or on the dielectric substrate, the first antenna group including at least one first radiating element;
a second antenna group disposed next to the first antenna group in a plan view seen from a direction normal to the dielectric substrate, the second antenna group including at least one second radiating element; and
a first dielectric layer disposed to cover the second antenna group, wherein
the at least one second radiating element is a linear antenna,
a dielectric constant of the first dielectric layer is higher than a dielectric constant of the dielectric substrate, and
a thickness of the first dielectric layer is smaller than a thickness of the dielectric substrate.

9. The antenna module according to claim 8, further comprising:
a third antenna group disposed next to the first antenna group in the plan view, the third antenna group including at least one third radiating element, wherein
the at least one third radiating element is a linear antenna,
the at least one third radiating element is configured to emit a radio wave in a direction different from a direction in which the at least one second radiating element emits a radio wave, and
the first dielectric layer is disposed to further cover the third antenna group.

10. The antenna module according to claim 9, further comprising:
a fourth antenna group disposed next to the first antenna group in the plan view, the fourth antenna group including at least one fourth radiating element; and
a fifth antenna group disposed next to the first antenna group in the plan view, the fifth antenna group including at least one fifth radiating element, wherein
the at least one fourth radiating element and the at least one fifth radiating element are linear antennas,
the first dielectric layer is disposed to further cover the fourth antenna group and the fifth antenna group,
the at least one fourth radiating element is configured to emit a radio wave in a direction different from directions in which the at least one second radiating element and the at least one third radiating element emit radio waves,
the at least one fifth radiating element is configured to emit a radio wave in a direction different from directions in which the at least one second radiating element, the at least one third radiating element, and the at least one fourth radiating element emit radio waves.

11. The antenna module according to claim 1, further comprising:
a second dielectric layer disposed in an area where the first dielectric layer is not present in the plan view, wherein
a dielectric constant of the second dielectric layer is lower than the dielectric constant of the first dielectric layer, and
in the direction normal to the dielectric substrate, a location of a surface of the first dielectric layer is same as a location of a surface of the second dielectric layer.

12. The antenna module according to claim 1, further comprising:
a feed circuit that supplies a radio frequency signal to each radiating element.

13. A communication device equipped with the antenna module according to claim 1.

14. The antenna module according to claim 1, wherein
the first radiating element is a patch antenna, and the dielectric substrate has a ground electrode facing the first radiating element,
the thickness of the first dielectric layer is smaller than a distance between the first radiating element and the ground electrode.

15. The antenna module according to claim 1, wherein
in a thickness direction of the dielectric substrate, the first dielectric layer is placed further outside the dielectric substrate than the first radiating element.

16. The antenna module according to claim 1, wherein
the first radiating element is a patch antenna, and the dielectric substrate includes a ground electrode facing the first radiating element,
in the normal direction to the dielectric substrate, the second radiating element is positioned between the first radiating element and the ground electrode.

17. The antenna module according to claim 10, wherein
in the plan view, the first antenna group is disposed in between the second antenna group and the third antenna group in a third direction and in between the fourth antenna group and the fifth antenna group in a fourth direction, the fourth direction being orthogonal to the third direction.

18. The antenna module according to claim 12, wherein the feed circuit upconverts a baseband signal to generate the radio frequency signal.

19. The antenna module according to claim 18, further comprising:
a baseband circuit to generate the baseband signal.

20. The antenna module according to claim 19, further comprising:
a plurality of switches to switch the feed circuit and baseband circuit from transmit to receive mode.
